(19) United States
(12) Patent Application Publication
(10) Pub. No.: US 2026/0063539 A1
(43) Pub. Date: Mar. 5, 2026

(54) CONCENTRATION MEASUREMENT DEVICE AND CONCENTRATION MEASUREMENT METHOD

(71) Applicant: HAMAMATSU PHOTONICS K.K., Hamamatsu-shi, Shizuoka (JP)

(72) Inventors: Kosuke HIRONAKA, Shizuoka (JP); Shigeo HARA, Shizuoka (JP)

(73) Assignee: HAMAMATSU PHOTONICS K.K., Hamamatsu-shi, Shizuoka (JP)

(21) Appl. No.: 19/310,277

(22) Filed: Aug. 26, 2025

(30) Foreign Application Priority Data
Aug. 28, 2024 (JP) 2024-146180

(51) Int. Cl. G01N 21/31; G01N 21/03; G01N 21/27

(52) U.S. Cl. CPC G01N 21/31; G01N 21/0303; G01N 21/27

(57) ABSTRACT

A concentration measurement device includes a well; a light irradiator; a light detector; and an arithmetic processor. The well includes a side wall having a tubular shape and a bottom portion closing one end of the side wall, and stores a liquid, in which a sample is dissolved or suspended in water, in an internal region formed by the side wall and the bottom portion. The light irradiator irradiates the liquid with a first light having a first wavelength and a second light having a second wavelength. The light detector detects light intensities of the first light and the second light that have passed through the liquid. The arithmetic processor calculates a concentration of the sample in the liquid based on an optical path length of the first light in the liquid and a second absorbance that is an absorbance of the liquid for the second light.

### CROSS REFERENCE

Priority is claimed on Japanese Patent Application No. 2024-146180, filed on Aug. 28, 2024, the entire content of which is incorporated herein by reference.

### TECHNICAL FIELD

The present disclosure relates to a concentration measurement device and a concentration measurement method.

### BACKGROUND

U.S. Pat. No. 6,404,501 discloses a measurement method for determining an optical path length of a sample stored in a well and including a solvent and an analyte dissolved or suspended in the solvent. In this method, a first optical signal generated by the transmission of light having a first wavelength perpendicularly through the sample is measured, and a second optical signal generated by the transmission of light having a second wavelength perpendicularly through the sample is measured. The wavelength of the first light and the wavelength of the second light are included in a near-infrared range of 750 nm to 2500 nm. Then, the optical path length of the sample is determined based on a predetermined relationship between both the first optical signal and the second optical signal and an optical path length of the solvent. Furthermore, a third optical signal generated by the transmission of light having a third wavelength through the sample is measured, and the first optical signal, the second optical signal, and the third optical signal are associated with each other according to a predetermined relationship. Accordingly, the ratio of the light having the third wavelength that is transmitted by the analyte or the absorbance of the analyte at the third wavelength is determined with respect to a light absorption path length of the analyte.

The concentration of a sample in a liquid in which the sample is dissolved or suspended in water is measured, for example, by the following method. First, the liquid is stored in a well. A first light having a wavelength that is less absorbed by the sample and more absorbed by water is caused to pass through the liquid, and the intensity of the first light after passing through is detected. A second light having a wavelength that is more absorbed by the sample and less absorbed by water is caused to pass through the liquid, and the intensity of the second light after passing through is detected. Then, an optical path length is calculated based on an absorbance calculated from the intensity of the first light after passing through, and the concentration of the sample is calculated based on the optical path length and an absorbance calculated from the intensity of the second light after passing through.

### SUMMARY

In the above-described method, it is assumed that a length of an optical path in the liquid through which the first light passes is equal to a length of an optical path in the liquid through which the second light passes. Therefore, when these lengths are different from each other, the measurement accuracy of the concentration of the sample decreases. However, it may be difficult to make these lengths equal to each other depending on the position where each of the first light and the second light passes through the liquid. An object of the present disclosure is to provide a concentration measurement device and a concentration measurement method capable of improving the measurement accuracy of the concentration of a sample by bringing the length of an optical path in a liquid through which a first light passes and the length of an optical path in the liquid through which a second light passes close to each other.

A concentration measurement device according to the present disclosure includes a well; a light irradiator; a light detector; and an arithmetic processor. The well includes a side wall having a tubular shape and extending along a first direction and a bottom portion closing one end of the side wall having a tubular shape, and stores a liquid, in which a sample is dissolved or suspended in water, in an internal region formed by the side wall and the bottom portion. The light irradiator irradiates the liquid with a first light having a first wavelength and a second light having a second wavelength such that the first light and the second light pass through both the bottom portion of the well and a liquid surface of the liquid. The light detector detects light intensities of the first light and the second light that have passed through the liquid. The arithmetic processor calculates a concentration of the sample in the liquid based on an optical path length of the first light in the liquid, which is calculated from a first absorbance that is an absorbance of the liquid for the first light, and a second absorbance that is an absorbance of the liquid for the second light. A concentration measurement method according to the present disclosure includes storing; detecting; and calculating. In the storing, a liquid in which a sample is dissolved or suspended in water is stored in an internal region formed by a side wall and a bottom portion of a well including the side wall having a tubular shape and extending along a first direction and the bottom portion closing one end of the side wall having a tubular shape. In the irradiating, the liquid is irradiated with a first light having a first wavelength and a second light having a second wavelength such that the first light and the second light pass through both the bottom portion of the well and a liquid surface of the liquid. In the detecting, light intensities of the first light and the second light that have passed through the liquid are detected. In the calculating, a concentration of the sample in the liquid is calculated based on an optical path length of the first light in the liquid, which is calculated from a first absorbance that is an absorbance of the liquid for the first light, and a second absorbance that is an absorbance of the liquid for the second light. In the concentration measurement device and the concentration measurement method, an absorbance of the sample at the first wavelength is 0.005 or less, and an absorbance of water at the first wavelength is 0.2 or more. An absorbance of the sample at the second wavelength is 0.05 or more, and an absorbance of water at the second wavelength is 0.005 or less. The light detector (or the detecting) detects the light intensities of the first light and the second light that have passed through a center of the internal region or a position spaced apart from the center of the internal region by a distance of ¼ or less of an inner diameter of the side wall when viewed in the first direction.

According to the present disclosure, it is possible to provide the concentration measurement device and the concentration measurement method capable of improving the measurement accuracy of the concentration of the sample by bringing the length of an optical path in the liquid through which the first light passes and the length of an optical path in the liquid through which the second light passes close to each other.

The present invention will be more fully understood from the detailed description given herein below and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view schematically illustrating a configuration of a concentration measurement device according to an embodiment of the present disclosure.

FIG. 2 is a graph illustrating a relationship between both a first wavelength and a second wavelength and the absorption spectra of water and a sample.

FIG. 3 is a view of a well when viewed in a first direction.

FIG. 4A is a view illustrating a configuration example of a light irradiator.

FIG. 4B is a view illustrating a configuration example of the light irradiator.

FIG. 4C is a view illustrating a configuration example of the light irradiator.

FIG. 5A is a view illustrating a configuration example of the light irradiator.

FIG. 5B is a view illustrating a configuration example of the light irradiator.

FIG. 6A is a view illustrating a configuration example of a light detector.

FIG. 6B is a view illustrating a configuration example of the light detector.

FIG. 7A is a view illustrating a configuration example of the light detector.

FIG. 7B is a view illustrating a configuration example of the light detector.

FIG. 8A is a view illustrating a configuration example of the light detector.

FIG. 8B is a view illustrating a configuration example of the light detector.

FIG. 9 is a flowchart illustrating a concentration measurement method according to the embodiment.

FIG. 10 is a view schematically illustrating a configuration of a concentration measurement device according to a modification example.

### DETAILED DESCRIPTION

A specific example of the present disclosure will be described below with reference to the drawings. The present invention is not limited to this example, but is defined by the claims, and it is intended that the present invention includes all modifications within the concept and scope equivalent to the claims. In the following description, the same elements in the description of the drawings are denoted by the same reference signs, and duplicate descriptions will be omitted.

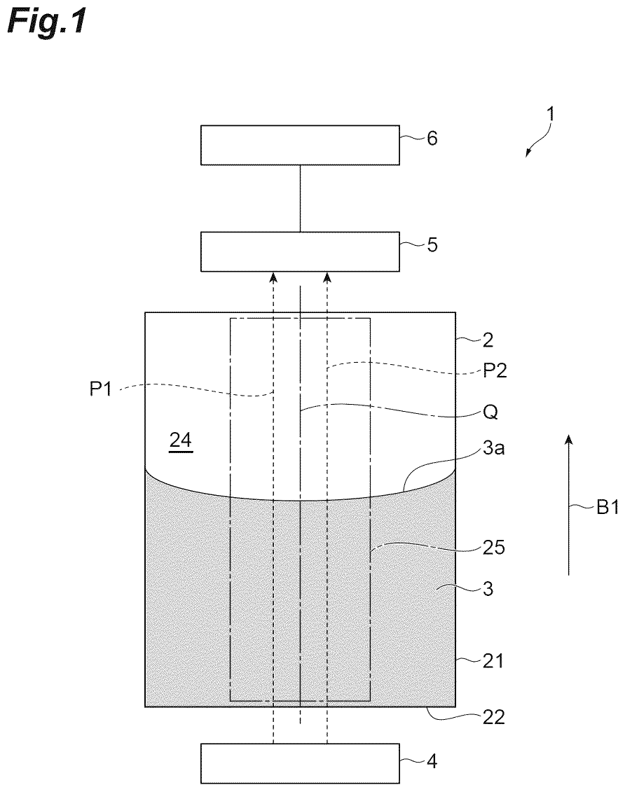

FIG. 1 is a view schematically illustrating a configuration of a concentration measurement device 1 according to an embodiment of the present disclosure. As illustrated in FIG. 1, the concentration measurement device 1 includes a well 2, a light irradiator 4, a light detector 5, and an arithmetic processor 6.

The well 2 is a hollow container including a side wall 21 and a bottom portion 22. The well 2 has an internal region 24 formed by the side wall 21 and the bottom portion 22. The side wall 21 has a tubular shape extending along a first direction B1, and in one example, has a cylindrical shape. An upper end of the side wall 21 having a tubular shape is open. The bottom portion 22 has a plate shape intersecting (for example, orthogonal to) the first direction B1, and closes a lower end of the side wall 21 having a tubular shape. The well 2 stores a liquid 3 in the internal region 24. The liquid 3 is stored in the well 2 by a user of the concentration measurement device 1 for each measurement. The liquid 3 is formed by dissolving or suspending a sample in water. The sample is added for the purpose of quantifying, for example, proteins, and undergoes a color reaction through a chemical reaction with proteins, complex formation, or the like. The sample is, for example, a triphenylmethane dye such as CBB G-250, a water-soluble tetrazolium salt such as WST-8, a Folin-Ciocalteu reagent, or the like. The liquid 3 has a liquid surface 3a. The liquid surface 3a is curved in a concave shape due to the surface tension of the liquid 3 and the like. The height of the liquid surface 3a from the bottom portion 22 is at its highest at a peripheral edge portion of the liquid surface 3a, and is at its lowest at a central portion of the liquid surface 3a (in other words, the center of the side wall 21 having a tubular shape).

The light irradiator 4 is disposed outside the well 2, and irradiates the liquid 3 with a first light P1 and a second light P2. The light irradiator 4 irradiates the liquid 3 with the first light P1 and the second light P2 such that the first light P1 and the second light P2 pass through both the bottom portion 22 and the liquid surface 3a. In the illustrated example, the light irradiator 4 is disposed on a lower end side (bottom portion 22 side) with respect to the well 2; however, the light irradiator 4 may be disposed on an upper end side with respect to the well 2. Optical axes of the first light P1 and the second light P2 may be parallel to the first direction B1, or may be inclined with respect to the first direction B1. The optical axis of the second light P2 is parallel to the optical axis of the first light P1. The optical axis of the second light P2 may coincide with the optical axis of the first light P1, or may be spaced apart from the optical axis of the first light P1. The light irradiator 4 includes, for example, a semiconductor laser element, and the first light P1 and the second light P2 are, for example, laser beams. Alternatively, the light irradiator 4 may include, for example, a surface-emitting LED and an optical system that collimates light from the surface-emitting LED. Alternatively, the light irradiator 4 may include, for example, a white light source and a spectrometer that spectrally separates white light from the white light source.

The first light P1 has a first wavelength λ₁ as a center wavelength. The first wavelength λ₁ is in a wavelength range in which the absorbance of water is in a range of 0.2 to 2 (in terms of conversion, a wavelength range in which the molar absorption coefficient of water is in a range of 0.4 (L/mol·cm) to 4 (L/mol·cm)), for example, in a range of 930 nm to 1100 nm or 1150 nm to 1380 nm. Alternatively, the first wavelength λ₁ may be in a wavelength range in which the absorbance of water is in a range of 0.5 to 1 (in terms of conversion, a wavelength range in which the molar absorption coefficient of water is in a range of 1 (L/mol·cm) to 2 (L/mol·cm)), for example, in a range of 1150 nm to 1350 nm. When the first wavelength λ₁ is included in these ranges, sufficient transmitted light can be ensured even when the optical path length is long, for example, 15 mm to 20 mm. In addition, since the intensity of the transmitted light is expected to change by 1% or more every time the optical path length changes by 1 mm, high resolution can be ensured. The wavelength width of the first light P1 is, for example, within λ₁±5 nm.

The second light P2 has a second wavelength λ₂ as a center wavelength that is different from the first wavelength λ₁. The second wavelength λ₂ is included in a wavelength range in which the absorbance of the sample is in a range of 0.05 to 1.5 (in terms of conversion, a wavelength range in which the molar absorption coefficient of the sample is in a range of 9×10⁶ (L/mol·cm) to 3×10¹⁰ (L/mol·cm)). Since the sample such as a dye to be measured often has an absorption peak in a visible light range of 400 nm to 750 nm, a wavelength included in a range of 400 nm to 750 nm is often used as the second wavelength λ₂. It is preferable that the wavelength width of the second light P2 is narrower than the absorption wavelength range of the sample.

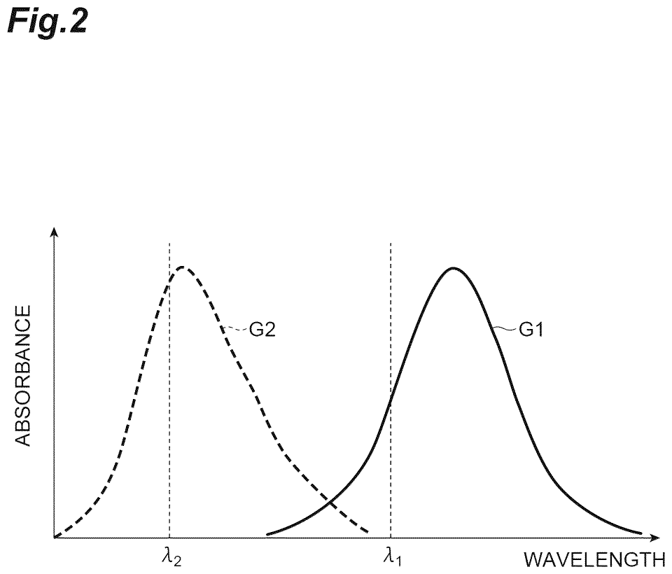

FIG. 2 is a graph illustrating a relationship between both the first wavelength λ₁ and the second wavelength λ₂ and the absorption spectra of water and the sample. In FIG. 2, the horizontal axis represents wavelength, and the vertical axis represents absorbance. Curve G1 represents the absorption spectrum of water, and curve G2 represents the absorption spectrum of the sample. As illustrated in FIG. 2, the first wavelength λ₁ is included in the absorption wavelength range of water, and is substantially not included in the absorption wavelength range of the sample. The second wavelength λ₂ is included in the absorption wavelength range of the sample, and is substantially not included in the absorption wavelength range of water.

Specifically, the absorbance of the sample at the first wavelength λ₁ is 0.005 or less, 0.002 or less, or 0.001 or less. Alternatively, the molar absorption coefficient of the sample at the first wavelength λ₁ is 9×10⁵ (L/mol·cm) or less or 1×10⁶ (L/mol·cm) or less. The absorbance of water at the first wavelength λ₁ is 0.2 or more or 0.5 or more and 2.0 or less or 1.0 or less. Alternatively, the molar absorption coefficient of water at the first wavelength λ₁ is 0.4 (L/mol·cm) or more or 1 (L/mol·cm) or more and 4 (L/mol·cm) or less or 2 (L/mol·cm) or less. The absorbance of the sample at the second wavelength λ₂ is 0.05 or more or 0.3 or more and 1.5 or less or 1.0 or less. Alternatively, the molar absorption coefficient of the sample at the second wavelength λ₂ is 9×10⁶ (L/mol·cm) or more or 6×10⁷ (L/mol·cm) or more and 3×10¹⁰ (L/mol·cm) or less or 2×10¹⁰ (L/mol·cm) or less. The absorbance of water at the second wavelength λ₂ is 0.005 or less, 0.002 or less, or 0.001 or less. Alternatively, the molar absorption coefficient of water at the second wavelength λ₂ is 0.002 (L/mol·cm) or less or 0.001 (L/mol·cm) or less.

In one example, the first wavelength λ₁ is at least 300 nm or 500 nm longer than the second wavelength λ₂. When the first wavelength λ₁ is at least 300 nm longer than the second wavelength λ₂, the absorbance of the sample at the first wavelength λ₁ becomes low enough not to affect the optical path length measurement, and the absorbance of water at the second wavelength λ₂ becomes low enough not to affect the concentration measurement.

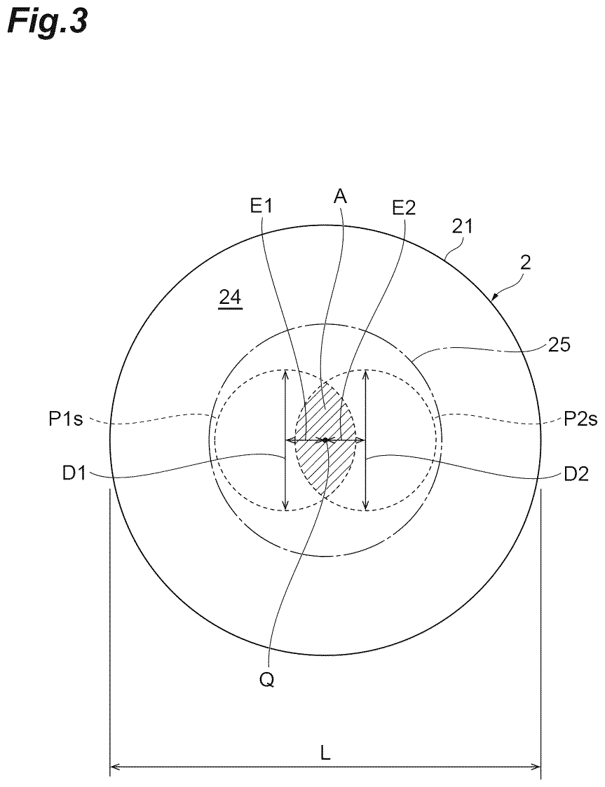

FIG. 3 is a view of the well 2 when viewed in the first direction B1. In FIG. 3, in addition to the side wall 21 of the well 2, a first spot Pls and a second spot P2s are illustrated. The first spot Pls is defined as a region where a light intensity of the first light P1 is 36.8% or more of the light intensity at the peak position of the first light P1 (typically, the optical axis position of the first light P1), namely, the peak intensity. The second spot P2s is defined as a region where a light intensity of the second light P2 is 36.8% or more of the light intensity at the peak position of the second light P2 (typically, the optical axis position of the second light P2), namely, the peak intensity. Typically, the cross-sections of the first spot Pls and the second spot P2s perpendicular to an optical axis direction have a circular shape. A diameter D1 of the first spot PIs and a diameter D2 of the second spot P2s are ⅓ or less of an inner diameter L of the side wall 21. In one example, the inner diameter L of the side wall 21 is 10 mm or less. In one example, the diameter D1 of the first spot Pls and the diameter D2 of the second spot P2s are 2 mm or less. A distance E1 between the peak position of the light intensity of the first light P1 (typically, the center of the first spot Pls) and a center line Q of the internal region 24 along the first direction B1 is, for example, ⅙ or less of the inner diameter L of the side wall 21. Similarly, a distance E2 between the peak position of the light intensity of the second light P2 (typically, the center of the second spot P2s) and the center line Q of the internal region 24 is, for example, ⅙ or less of the inner diameter L of the side wall 21. The distance E1 and the distance E2 may be equal to each other or may be different from each other. The peak position of the light intensity of the first light P1 may coincide with the peak position of the light intensity of the second light P2.

When viewed in the first direction B1, the first spot Pls and the second spot P2s overlap each other. An area of an overlap A (illustrated by hatching in the figure) between the first spot Pls and the second spot P2s is 35% or more of an area of the first spot Pls, and is 35% or more of an area of the second spot P2s. The overlap A includes the center line Q of the internal region 24. In one example, the center of the overlap A coincides with the center line Q of the internal region 24.

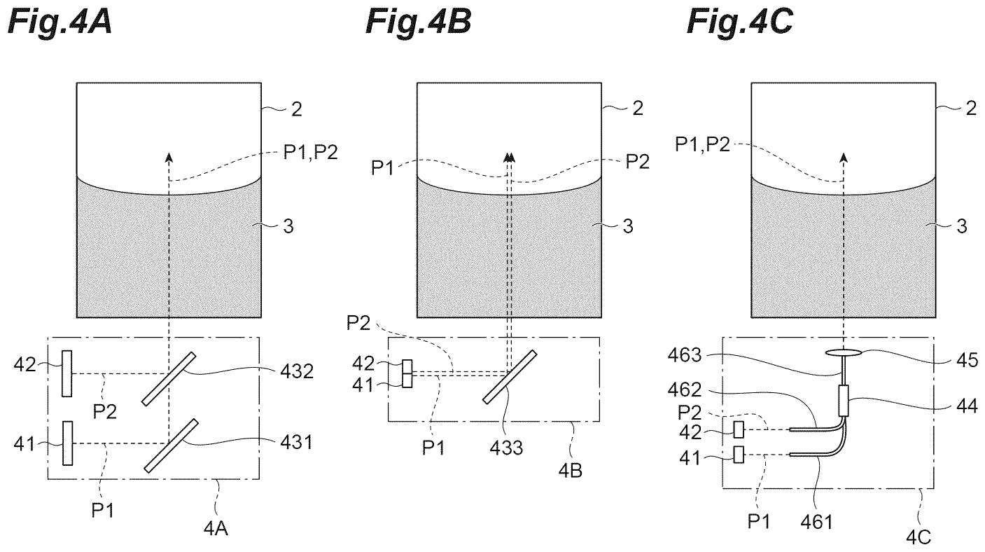

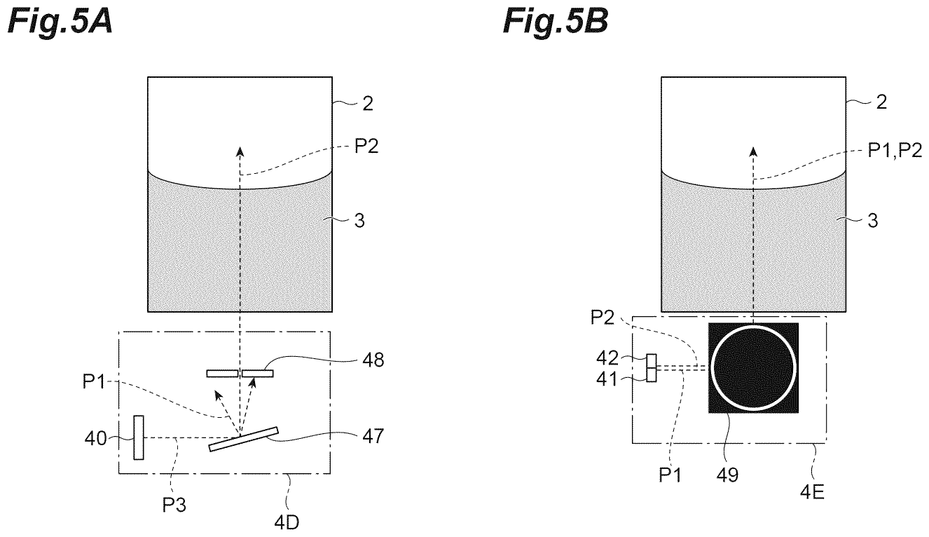

The light irradiator 4 may include a single light source that outputs both the first light P1 and the second light P2. Alternatively, the light irradiator 4 may include a first light source that outputs the first light P1, and a second light source that is provided separately from the first light source and that outputs the second light P2. FIGS. 4A, 4B, 4C, 5A, and 5B are views illustrating various configuration examples of the light irradiator 4.

A light irradiator 4A illustrated in FIG. 4A includes a first light source 41, a second light source 42, a mirror 431, and a mirror 432. The first light source 41 outputs the first light P1 with an optical axis intersecting an extending direction of an optical path of the first light P1 in the liquid 3. The second light source 42 outputs the second light P2 with an optical axis intersecting an extending direction of an optical path of the second light P2 in the liquid 3. The mirror 431 is, for example, a metal mirror, a dielectric multilayer mirror, or a prism mirror that reflects approximately the entire amount of light, and reflects the first light P1 toward the liquid 3. The mirror 432 is, for example, a half mirror, a beam splitter, or a dichroic mirror, and transmits the first light P1 and reflects the second light P2 toward the liquid 3. At this time, the first light P1 and the second light P2 overlap each other. The disposition of the first light source 41 may be interchanged with the disposition of the second light source 42.

A light irradiator 4B illustrated in FIG. 4B includes the first light source 41, the second light source 42, and a mirror 433. The first light source 41 is disposed close to the second light source 42. The first light source 41 and the second light source 42 output the first light P1 and the second light P2 in parallel to each other, with optical axes intersecting the extending direction of the optical path of the second light P2 in the liquid 3. The mirror 433 is, for example, a metal mirror, a dielectric multilayer mirror, or a prism mirror that reflects approximately the entire amount of light, and reflects the first light P1 and the second light P2 toward the liquid 3. The first light source 41 and the second light source 42 may output the first light P1 and the second light P2 toward the liquid 3. In that case, the mirror 433 may not be provided.

A light irradiator 4C illustrated in FIG. 4C includes the first light source 41, the second light source 42, and a lens 45. The light irradiator 4C further includes an optical fiber coupler 44 including optical fibers 461, 462, and 463. The first light source 41 inputs the first light P1 to one end of the optical fiber 461. The second light source 42 inputs the second light P2 to one end of the optical fiber 462. The optical fiber coupler 44 multiplexes the first light P1 propagating through the optical fiber 461 and the second light P2 propagating through the optical fiber 462, and outputs the multiplexed light from the optical fiber 463. The lens 45 collimates the multiplexed light output from the optical fiber 463.

A light irradiator 4D illustrated in FIG. 5A includes a light source 40, a diffraction grating 47, and an aperture 48. The light source 40 outputs a third light P3 including both a wavelength component of the first wavelength λ₁ and a wavelength component of the second wavelength λ₂. The third light P3 is, for example, white light. The diffraction grating 47 spectrally separates the third light P3 into a plurality of wavelength components. At this time, the wavelength component of the first wavelength λ₁, namely, the first light P1 and the wavelength component of the second wavelength λ₂, namely, the second light P2 are emitted in different directions. The aperture 48 passes one of the first light P1 or the second light P2 depending on the angle of the diffraction grating 47. The first light P1 or the second light P2 passing through the aperture 48 is incident on the liquid 3.

A light irradiator 4E illustrated in FIG. 5B includes the first light source 41, the second light source 42, and an integrating sphere 49. The first light source 41 inputs the first light P1 to the integrating sphere 49. The second light source 42 inputs the second light P2 to the integrating sphere 49. The integrating sphere 49 scatters and multiplexes the first light P1 and the second light P2 inside the integrating sphere 49, and outputs the multiplexed light. The guidance of light from the first light source 41 and the second light source 42 to the integrating sphere 49 may be the guidance of light by spatial propagation or may be the guidance of light by an optical waveguide or an optical fiber. Alternatively, the first light source 41 and the second light source 42 may be disposed inside the integrating sphere 49. The guidance of light from the integrating sphere 49 to the liquid 3 may also performed by spatial propagation or may also be the guidance of light by an optical waveguide or an optical fiber. The light emitted from the integrating sphere 49 may be collimated by a lens or the like.

Referring again to FIG. 1, the light detector 5 detects the light intensities of the first light P1 and the second light P2 that have passed through the liquid 3. In the illustrated example, the light detector 5 is disposed on the upper end side with respect to the well 2; however, when the light irradiator 4 is disposed on the upper end side with respect to the well 2, the light detector 5 may be disposed on the lower end side (bottom portion 22 side) with respect to the well 2.

The light detector 5 detects the light intensities of the first light P1 and the second light P2 that have passed through the center of the internal region or a position spaced apart from the center of the internal region 24 by a distance of ¼ or less of the inner diameter L of the side wall 21 when viewed in the first direction B1. In one example, the light irradiator 4 causes the first light P1 and the second light P2 to pass through a region 25 to which the distance from the center line Q of the internal region 24 is ¼ or less of the inner diameter L, and the light detector 5 detects the first light P1 and the second light P2. Such a mode is adopted, for example, when the light irradiator 4 includes a semiconductor laser element. In this case, the size of a light receiving surface of the light detector 5 is not particularly limited, and the light receiving surface of a light detection element may be larger than an opening of the well 2. Alternatively, in another example, the light irradiator 4 causes only a part of each of the first light P1 and the second light P2 to pass through the region 25, and the light detector 5 selectively detects only the part of each of the first light P1 and the second light P2. Such a mode is adopted, for example, when the light irradiator 4 includes a surface-emitting LED. In this case, the size of the light receiving surface of the light detector 5 is limited such that only a part of each of the first light P1 and the second light P2 can be selectively detected.

The light detector 5 may include a single light detection element that detects the light intensities of both the first light P1 and the second light P2. In this case, the light detection element can be composed of, for example, semiconductor quantum dots having a diameter of 3 nm to 13 nm and made of PbS, InAs, or the like, or an organic semiconductor. Alternatively, the light detector 5 may include a first light detection element that detects the light intensity of the first light P1, and a second light detection element that is provided separately from the first light detection element and that detects the light intensity of the second light P2. In that case, the light detection elements can be composed of semiconductor quantum dots, organic semiconductors, Si, InGaAs, graphene, or carbon nanotubes.

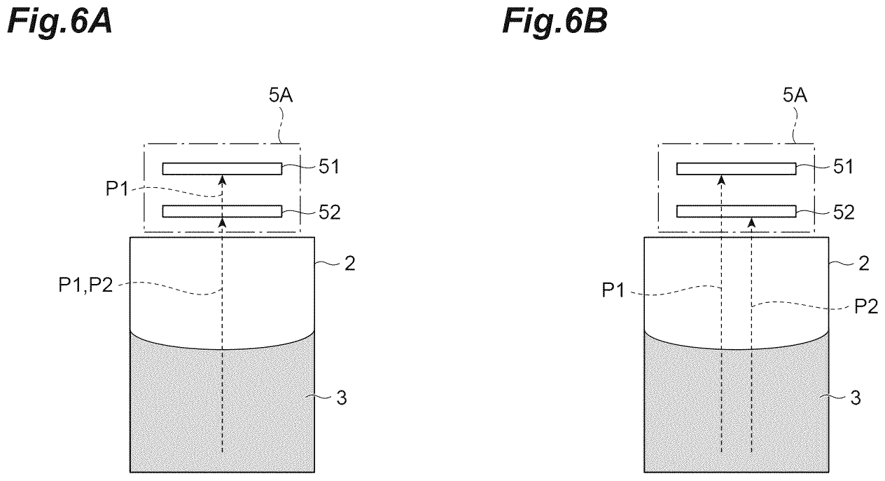

FIGS. 6A, 6B, 7A, 7B, 8A, and 8B are views illustrating various configuration examples of the light detector 5. A light detector 5A illustrated in FIGS. 6A and 6B includes a first light detection element 51 and a second light detection element 52. FIG. 6A illustrates a case where the optical axis of the first light P1 coincides with the optical axis of the second light P2, and FIG. 6B illustrates a case where the optical axis of the first light P1 is spaced apart from the optical axis of the second light P2. In this example, the second light detection element 52 is disposed between the first light detection element 51 and the well 2. When viewed in the first direction B1, the second light detection element 52 overlaps the first light detection element 51. The first light detection element 51 has sensitivity to the first wavelength λ₁ and detects the light intensity of the first light P1. The second light detection element 52 has sensitivity mainly to the second wavelength λ₂, and detects the light intensity of the second light P2. The second light detection element 52 has a significantly lower sensitivity to the first wavelength λ₁ than to the second wavelength λ₂, and transmits the first light P1. The disposition of the first light detection element 51 may be interchanged with the disposition of the second light detection element 52. In that case, the first light detection element 51 has a significantly lower sensitivity to the second wavelength λ₂ than to the first wavelength λ₁, and transmits the second light P2.

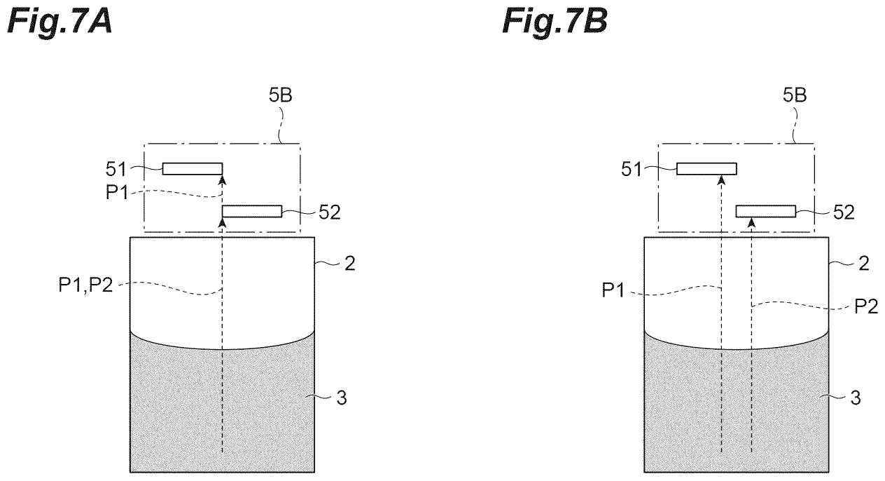

A light detector 5B illustrated in FIGS. 7A and 7B includes the first light detection element 51 and the second light detection element 52. FIG. 7A illustrates a case where the optical axis of the first light P1 coincides with the optical axis of the second light P2, and FIG. 7B illustrates a case where the optical axis of the first light P1 is spaced apart from the optical axis of the second light P2. In this example, the second light detection element 52 is disposed closer to the well 2 than the first light detection element 51. However, unlike the example of FIGS. 6A and 6B, when viewed in the first direction B1, the second light detection element 52 does not overlap (or slightly overlaps) the first light detection element 51, and is close to the first light detection element 51.

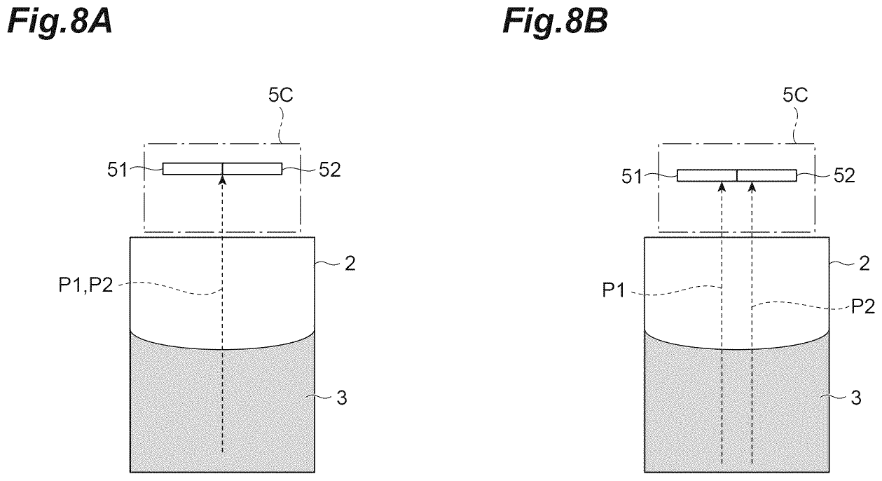

A light detector 5C illustrated in FIGS. 8A and 8B includes the first light detection element 51 and the second light detection element 52. FIG. 8A illustrates a case where the optical axis of the first light P1 coincides with the optical axis of the second light P2, and FIG. 8B illustrates a case where the optical axis of the first light P1 is spaced apart from the optical axis of the second light P2. In this example, a distance from the second light detection element 52 to the well 2 is the same as a distance from the first light detection element 51 to the well 2. When viewed in the first direction B1, the second light detection element 52 is close to the first light detection element 51.

In the examples illustrated in FIGS. 7A, 7B, 8A, and 8B, a part of the first light P1 is incident on the first light detection element 51, and the remainder of the first light P1 is incident on the second light detection element 52. Furthermore, a part of the second light P2 is incident on the second light detection element 52, and the remainder of the second light P2 is incident on the first light detection element 51. The first light detection element 51 has a significantly lower sensitivity to the second wavelength λ₂ than to the first wavelength λ₁, and mainly detects the light intensity of the first light P1. The second light detection element 52 has a significantly lower sensitivity to the first wavelength λ₁ than to the second wavelength λ₂, and mainly detects the light intensity of the second light P2.

Referring again to FIG. 1, the arithmetic processor 6 is connected to the light detector 5 by wire or wirelessly. The arithmetic processor 6 calculates the concentration of the sample in the liquid 3 based on an optical path length of the first light P1 in the liquid 3, which is calculated from a first absorbance that is the absorbance of the liquid 3 for the first light P1, and a second absorbance that is the absorbance of the liquid 3 for the second light P2. Specifically, the absorbance is calculated by Equation (1) below. Here, A is the absorbance, I₀ is the amount of incident light, I is the amount of transmitted light, ε is the molar absorption coefficient, c is the concentration, and l is the optical path length.

$$\begin{matrix}[ Equation 1 ] & \\ A = - log ( \frac{I}{{I}_{0}} ) = ϵ cl & ( 1 )\end{matrix}$$

Therefore, the first absorbance A₁ and the second absorbance A₂ are calculated by Equations (2) and (3) below, respectively. Here, F₁ is the molar absorption coefficient of water, ε₂ is the molar absorption coefficient of the sample, c₁ is the concentration of water, c₂ is the concentration of the sample, and l is the optical path length. Here, it is assumed that the optical path length of the first light P1 in the liquid 3 is equal to an optical path length of the second light P2 in the liquid 3.

$$\begin{matrix}[ Equation 2 ] & \\ {A}_{1} = {ϵ}_{1} {c}_{1} l & ( 2 )\end{matrix}$$

$$\begin{matrix}[ Equation 3 ] & \\ {A}_{2} = {ϵ}_{2} {c}_{2} l & ( 3 )\end{matrix}$$

The first absorbance A₁ obtained using the first light P1 that is not absorbed by the sample does not depend on the concentration of the sample. Therefore, the concentration c₁ is regarded as being approximately constant. Therefore, the optical path length l is obtained from Equation (2). Then, the concentration c₂ of the sample is calculated from Equation (3) using the obtained optical path length l.

The arithmetic processor 6 may be composed of a computer. Physically, the computer includes memories such as a RAM and a ROM, a processor (computation circuit) such as a CPU, a communication interface, a storage unit such as a hard disk, and a display unit such as a display. The computer is, for example, a personal computer, a cloud server, or a smart device (a smartphone, a tablet terminal, or the like). The computer functions as the arithmetic processor 6 by executing a program, which is stored in the memory, in the CPU of the computer system.

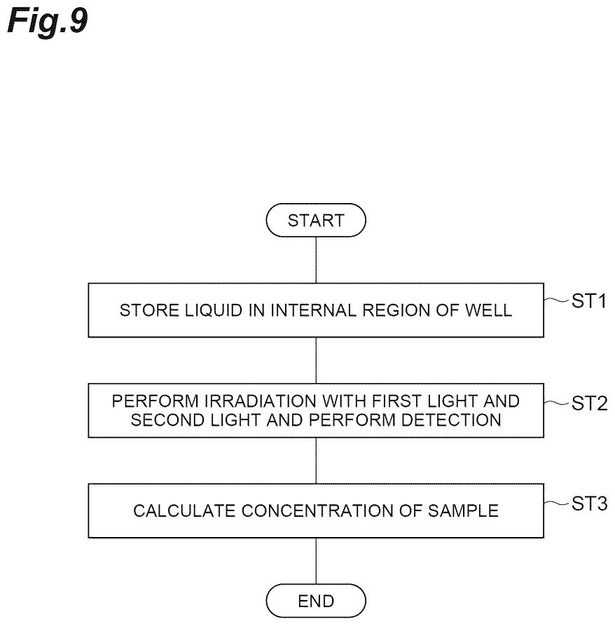

FIG. 9 is a flowchart illustrating a concentration measurement method according to the present embodiment. As illustrated in FIG. 9, the concentration measurement method according to the present embodiment includes storage step ST1, light detection step ST2, and computation step ST3. The concentration measurement method is performed, for example, using the concentration measurement device 1 described above.

In the storage step ST1, the liquid 3 is stored in the internal region 24 of the well 2. This work is performed by the user of the concentration measurement device 1. In the light detection step ST2, the liquid 3 is irradiated with the first light P1 and the second light P2 such that the first light P1 and the second light P2 pass through both the bottom portion 22 and the liquid surface 3a, and the light intensities of the first light P1 and the second light P2 that have passed through the liquid 3 are detected. In the light detection step ST2, the light intensities of the first light P1 and the second light P2 that have passed through the center of the internal region 24 or a position spaced apart from the center of the internal region 24 by a distance of ¼ or less of the inner diameter L of the side wall 21 when viewed in the first direction B1 are detected. In the light detection step ST2, a single light source that outputs both the first light P1 and the second light P2 may be used, or the first light source 41 that outputs the first light P1 and the second light source 42 that is provided separately from the first light source 41 and that outputs the second light P2 may be used. In the light detection step ST2, a single light detection element that detects the light intensities of both the first light P1 and the second light P2 may be used, or the first light detection element 51 that detects the light intensity of the first light P1 and the second light detection element 52 that detects the light intensity of the second light P2 may be used. In the computation step ST3, in accordance with Equations (2) and (3) described above, the concentration c₂ of the sample in the liquid 3 is calculated based on the optical path length l of the first light P1 in the liquid 3, which is calculated from the first absorbance A₁ that is the absorbance of the liquid 3 for the first light P1, and the second absorbance A₂ that is the absorbance of the liquid 3 for the second light P2.

Effects obtained by the concentration measurement device 1 and the concentration measurement method according to the present embodiment described above will be described. The liquid surface 3a of the liquid 3 stored in the well 2 is not flat, but has deformation (meniscus) due to surface tension and the like. As illustrated in FIG. 1, the height of the liquid surface 3a is at its highest at the peripheral edge portion of the liquid surface 3a, and decreases as the central portion of the liquid surface 3a is approached. Furthermore, the rate of change in the height of the liquid surface 3a in a radial direction of the well 2 is at its largest at the peripheral edge portion of the liquid surface 3a, and decreases as the central portion of the liquid surface 3a is approached. In other words, it can be said that the closer to the central portion of the liquid surface 3a is, the more stable the height of the liquid surface 3a is. In the concentration measurement device 1 and the concentration measurement method of the present embodiment, the light intensities of the first light P1 and the second light P2 that have passed through the center of the internal region 24 or a position spaced apart from the center of the internal region 24 by a distance of ¼ or less of the inner diameter L of the side wall 21 when viewed in the first direction B1 are detected. In this way, by detecting the light intensities of the first light P1 and the second light P2 passing through the vicinity of the center of the liquid surface 3a, the influence of the meniscus can be reduced, and the optical path length l of the first light P1 in the liquid 3 can be brought close to the optical path length l of the second light P2 in the liquid 3. Therefore, the measurement accuracy of the concentration c₂ of the sample calculated by Equations (2) and (3) can be improved.

In addition, in the concentration measurement device 1 and the concentration measurement method of the present embodiment, the absorbance of the sample at the first wavelength λ₁ is 0.005 or less (the molar absorption coefficient is 9×10⁵ (L/mol·cm) or less), the absorbance of water at the first wavelength λ₁ is 0.2 or more (the molar absorption coefficient is 0.4 (L/mol·cm) or more), the absorbance of the sample at the second wavelength λ₂ is 0.05 or more (the molar absorption coefficient is 9×10⁶ (L/mol·cm) or more), and the absorbance of water at the second wavelength λ₂ is 0.005 or less (the molar absorption coefficient is 0.002 (L/mol·cm) or less). In this way, since the absorption of the first light P1 by water is significantly higher than the absorption of the first light P1 by the sample, and the absorption of the second light P2 by the sample is significantly higher than the absorption of the second light P2 by water, the measurement accuracy of the concentration of the sample can be further improved.

In addition, the smaller the inner diameter L of the well 2 becomes, the larger the curvature of the liquid surface due to the meniscus becomes. Furthermore, the state of the liquid surface 3a when the liquid 3 is initially introduced is significantly different from that when the liquid 3 is removed and then introduced again. In addition, the smaller the area of the bottom portion 22 of the well 2 is, the more significantly the height of the liquid surface 3a changes due to an increase in volume caused by the mixing in of bubbles. The optical path length l of the first light P1 and the second light P2 is likely to vary due to these factors. In the present embodiment, by measuring the optical path length l using the first wavelength λ₁ for measuring the optical path length l separately from the second wavelength λ₂ for measuring the sample, the measurement accuracy of the concentration c₂ of the sample can be improved even when the state of the liquid surface 3a changes or bubbles are mixed in.

As described above, the absorbance of water at the first wavelength λ₁ may be 2.0 or less (the molar absorption coefficient may be 4 (L/mol·cm) or less), and the absorbance of the sample at the second wavelength λ₂ may be 1.5 or less (the molar absorption coefficient may be 3×10¹⁰ (L/mol·cm) or less). In this way, since the absorption of the first light P1 by water and the absorption of the second light P2 by the sample are not too high, noise due to the influence of stray light can be reduced, and the measurement accuracy of the concentration of the sample can be further improved.

As described above, the absorbance of water at the first wavelength λ₁ may be 0.5 or more and 1.0 or less (the molar absorption coefficient may be 1 (L/mol·cm) or more and 2 (L/mol·cm) or less). In this case, since the difference between the absorption of the first light P1 by water and the absorption of the first light P1 by the sample is further increased and noise due to the influence of stray light can be further reduced, the measurement accuracy of the concentration of the sample can be further improved.

As described above, the absorbance of the sample at the first wavelength λ₁ may be 0.002 or less (the molar absorption coefficient may be 1×10⁶ (L/mol·cm) or less). In this case, since the difference between the absorption of the first light P1 by water and the absorption of the first light P1 by the sample is further increased, the measurement accuracy of the concentration of the sample can be further improved.

As described above, the absorbance of the sample at the second wavelength λ₂ may be 0.3 or more and 1.0 or less (the molar absorption coefficient may be 6×10⁷ (L/mol·cm) or more and 2×10¹⁰ (L/mol·cm) or less). In this case, since the difference between the absorption of the second light P2 by the sample and the absorption of the second light P2 by water is further increased and noise due to the influence of stray light can be further reduced, the measurement accuracy of the concentration of the sample can be further improved.

As described above, the absorbance of water at the second wavelength λ₂ may be 0.002 or less (the molar absorption coefficient may be 0.001 (L/mol·cm) or less). In this case, since the difference between the absorption of the second light P2 by the sample and the absorption of the second light P2 by water is further increased, the measurement accuracy of the concentration of the sample can be further improved.

As in the present embodiment, the inner diameter L of the side wall 21 may be 10 mm or less. When the well 2 having such a small inner diameter L is used, the influence of the meniscus is increased and the optical path length is likely to vary, so that the concentration measurement device 1 and the concentration measurement method according to the present embodiment are effective.

As described above, the light irradiator 4 may include a single light source that outputs both the first light P1 and the second light P2. Similarly, in the light detection step ST2, a single light source that outputs both the first light P1 and the second light P2 may be used. In this case, the number of light sources can be reduced, thereby simplifying the configuration of the device. In addition, since the passing position of the first light P1 and the passing position of the second light P2 coincide with or are close to each other, the measurement accuracy can be further improved.

As described above, the light irradiator 4 may include the first light source 41 that outputs the first light P1, and the second light source 42 that is provided separately from the first light source 41 and that outputs the second light P2. Similarly, in the light detection step ST2, the first light source 41 that outputs the first light P1 and the second light source 42 that is provided separately from the first light source 41 and that outputs the second light P2 may be used. In this case, since the wavelengths can be set individually for the first light source 41 and the second light source 42, the degree of freedom in selecting the first wavelength λ, and the second wavelength λ₂ can be increased.

As described above, the light detector 5 may include a single light detection element that detects the light intensities of both the first light P1 and the second light P2. Similarly, in the light detection step ST2, a single light detection element that detects the light intensities of both the first light P1 and the second light P2 may be used. In this case, the number of light detection elements can be reduced, thereby simplifying the configuration of the device. In addition, the passing position of the first light P1 and the passing position of the second light P2 can be easily made to coincide with or be brought close to each other, and the measurement accuracy can be further improved.

As described above, the light detector 5 may include the first light detection element 51 that detects the light intensity of the first light P1, and the second light detection element 52 that detects the light intensity of the second light P2. Similarly, in the light detection step ST2, the first light detection element 51 that detects the light intensity of the first light P1 and the second light detection element 52 that detects the light intensity of the second light P2 may be used. In this case, since the wavelength sensitivity characteristics can be set individually for the first light detection element 51 and the second light detection element 52, the degree of freedom in selecting the first wavelength λ, and the second wavelength λ₂ can be increased.

As described above, the light intensities of the first light P1 and the second light P2 that have passed through the center of the internal region 24 or a position spaced apart from the center of the internal region 24 by a distance of ⅙ or less of the inner diameter L of the side wall 21 when viewed in the first direction B1 may be detected. In this case, since the first light P1 and the second light P2 that are detected are closer to the center of the liquid surface 3a, the influence of the meniscus can be further reduced, and the optical path length l of the first light P1 in the liquid 3 can be brought closer to the optical path length l of the second light P2 in the liquid 3. Therefore, the measurement accuracy of the concentration of the sample can be further improved.

As described above, the area of the overlap A between the first spot Pls and the second spot P2s when viewed in the first direction B1 may be 35% or more of the area of the first spot Pls, and may be 35% or more of the area of the second spot P2s. In this case, by detecting the first absorbance A₁ and the second absorbance A₂ in the portion of the overlap A between the first spot Pls and the second spot P2s, the measurement error in the optical path length l due to the optical axis of the first light P1 and the optical axis of the second light P2 being spaced apart from each other can be reduced. Therefore, the measurement accuracy of the concentration of the sample can be further improved.

As described above, the diameter D1 of the first spot Pls and the diameter D2 of the second spot P2s may be ⅓ or less of the inner diameter L of the side wall 21. In this way, since the diameter D1 of the first spot Pls and the diameter D2 of the second spot P2s are not too large, the influence of stray light can be reduced, and the measurement accuracy of the concentration of the sample can be further improved. Particularly, when the inner diameter L of the side wall 21 is, for example, 6.6 mm or more, it is more effective that the diameter D1 of the first spot Pls and the diameter D2 of the second spot P2s are 2 mm or less.

### Modification Example

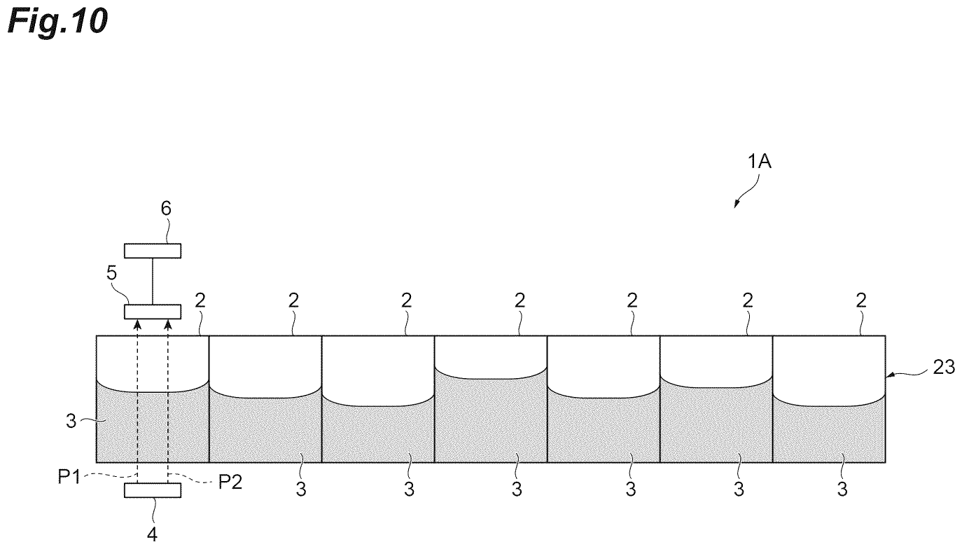

FIG. 10 is a view schematically illustrating a configuration of a concentration measurement device 1A according to a modification example of the above-described embodiment. The concentration measurement device 1A according to the present modification example includes a well plate 23 in which a plurality of the wells 2 having the same structure as in the above-described embodiment are provided side by side. The light irradiator 4 irradiates each of the liquids 3 in the plurality of wells 2 with both the first light P1 and the second light P2. The light detector 5 detects the light intensities of the first light P1 and the second light P2 that have passed through the liquids 3 in the plurality of wells 2. The arithmetic processor 6 calculates the concentration of the sample in the plurality of wells 2 for each well 2.

According to the present modification example, the concentrations of the sample in a plurality of the liquids 3 can be collectively measured, and the measurement process can be made efficient. In addition, measurement errors due to a difference in optical path length between the plurality of wells 2 can be reduced.

The concentration measurement device and the concentration measurement method according to the present disclosure are not limited to the above-described embodiment, and various other modifications can be implemented. For example, in the above-described embodiment, the inner diameter L of the side wall 21 of the well 2 is 10 mm or less; however, the inner diameter L may be more than 10 mm.

The concentration measurement device and the concentration measurement method according to the present disclosure are expressed as follows.

(1) A concentration measurement device according to the present disclosure includes a well; a light irradiator; a light detector; and an arithmetic processor. The well includes a side wall having a tubular shape and extending along a first direction and a bottom portion closing one end of the side wall having a tubular shape, and stores a liquid, in which a sample is dissolved or suspended in water, in an internal region formed by the side wall and the bottom portion. The light irradiator irradiates the liquid with a first light having a first wavelength and a second light having a second wavelength such that the first light and the second light pass through both the bottom portion of the well and a liquid surface of the liquid. The light detector detects light intensities of the first light and the second light that have passed through the liquid. The arithmetic processor calculates a concentration of the sample in the liquid based on an optical path length of the first light in the liquid, which is calculated from a first absorbance that is an absorbance of the liquid for the first light, and a second absorbance that is an absorbance of the liquid for the second light. A concentration measurement method according to the present disclosure includes storing; irradiating; detecting; and calculating. In the storing, a liquid in which a sample is dissolved or suspended in water is stored in an internal region formed by a side wall and a bottom portion of a well including the side wall having a tubular shape and extending along a first direction and the bottom portion closing one end of the side wall having a tubular shape. In the irradiating, the liquid is irradiated with a first light having a first wavelength and a second light having a second wavelength such that the first light and the second light pass through both the bottom portion of the well and a liquid surface of the liquid. In the detecting, light intensities of the first light and the second light that have passed through the liquid are detected. In the calculating, a concentration of the sample in the liquid is calculated based on an optical path length of the first light in the liquid, which is calculated from a first absorbance that is an absorbance of the liquid for the first light, and a second absorbance that is an absorbance of the liquid for the second light. In the concentration measurement device and the concentration measurement method, an absorbance of the sample at the first wavelength is 0.005 or less, and an absorbance of water at the first wavelength is 0.2 or more. An absorbance of the sample at the second wavelength is 0.05 or more, and an absorbance of water at the second wavelength is 0.005 or less. The light detector (or the detecting) detects the light intensities of the first light and the second light that have passed through the center of the internal region or a position spaced apart from the center of the internal region by a distance of ¼ or less of an inner diameter of the side wall when viewed in the first direction.

The liquid surface of the liquid stored in the well is not flat, but has deformation (meniscus) due to surface tension and the like. Typically, the height of the liquid surface is at its highest at a peripheral edge portion of the liquid surface, and decreases as a central portion of the liquid surface is approached. Furthermore, the rate of change in the height of the liquid surface in a radial direction of the well is at its largest at the peripheral edge portion of the liquid surface, and decreases as the central portion of the liquid surface is approached. In other words, it can be said that the closer to the central portion of the liquid surface is, the more stable the height of the liquid surface is. In the concentration measurement device and the concentration measurement method of (1) above, the light detector (or the detecting) detects the light intensities of the first light and the second light that have passed through the center of the internal region or a position spaced apart from the center of the internal region by a distance of ¼ or less of the inner diameter of the side wall when viewed in the first direction. In this way, by detecting the light intensities of the first light and the second light that have passed through the vicinity of the center of the liquid surface, the influence of the meniscus can be reduced, and the length of an optical path in the liquid through which the first light passes can be brought close to the length of an optical path in the liquid through which the second light passes. Therefore, the measurement accuracy of the concentration of the sample can be improved. In addition, in the concentration measurement device and the concentration measurement method of [1] above, the absorbance of the sample at the first wavelength is 0.005 or less, the absorbance of water at the first wavelength is 0.2 or more, the absorbance of the sample at the second wavelength is 0.05 or more, and the absorbance of water at the second wavelength is 0.005 or less. In this way, since the absorption of the first light by water is significantly higher than the absorption of the first light by the sample, and the absorption of the second light by the sample is significantly higher than the absorption of the second light by water, the measurement accuracy of the concentration of the sample can be further improved.

(2) In the concentration measurement device and the concentration measurement method of (1) above, the absorbance of water at the first wavelength may be 2.0 or less, and the absorbance of the sample at the second wavelength may be 1.5 or less. In this way, since the absorption of the first light by water and the absorption of the second light by the sample are not too high, noise due to the influence of stray light can be reduced, and the measurement accuracy of the concentration of the sample can be further improved.

(3) In the concentration measurement device and the concentration measurement method of (1) and (2) above, the absorbance of water at the first wavelength may be 0.5 or more and 1.0 or less. In this case, since the difference between the absorption of the first light by water and the absorption of the first light by the sample is further increased and noise due to the influence of stray light can be further reduced, the measurement accuracy of the concentration of the sample can be further improved.

(4) In the concentration measurement device and the concentration measurement method of (1) to (3) above, the absorbance of the sample at the first wavelength may be 0.002 or less. In this case, since the difference between the absorption of the first light by water and the absorption of the first light by the sample is further increased, the measurement accuracy of the concentration of the sample can be further improved.

(5) In the concentration measurement device and the concentration measurement method of (1) to (4) above, the absorbance of the sample at the second wavelength may be 0.3 or more and 1.0 or less. In this case, since the difference between the absorption of the second light by the sample and the absorption of the second light by water is further increased and noise due to the influence of stray light can be further reduced, the measurement accuracy of the concentration of the sample can be further improved.

(6) In the concentration measurement device and the concentration measurement method of (1) to (5) above, the absorbance of water at the second wavelength may be 0.002 or less. In this case, since the difference between the absorption of the second light by the sample and the absorption of the second light by water is further increased, the measurement accuracy of the concentration of the sample can be further improved.

(7) In the concentration measurement device and the concentration measurement method of (1) to (6) above, the inner diameter of the side wall having a tubular shape may be 10 mm or less. When the well having such a small inner diameter is used, the influence of the meniscus is increased and the optical path length is likely to vary, so that the concentration measurement device and the concentration measurement method of (1) to (6) above are effective.

(8) The concentration measurement device of (1) to (7) above may include a well plate in which the well and another well having the same structure as the well are provided side by side. The light irradiator may irradiate each of the liquid in the well and the liquid in the another well with both the first light and the second light. The light detector may detect the light intensities of the first light and the second light that have passed through the liquid in the well, and the light intensities of the first light and the second light that have passed through the liquid in the another well. The arithmetic processor may calculate the concentration of the sample in the well and the concentration of the sample in the another well. In this case, the concentrations of the sample in a plurality of the liquids can be collectively measured, and the measurement process can be made efficient. In addition, measurement errors due to a difference in optical path length between the plurality of wells can be reduced.

(9) In the concentration measurement device of (1) to (8) above, the light irradiator may include a single light source that outputs both the first light and the second light. Similarly, in the irradiating of the concentration measurement method of (1) to (8) above, a single light source that outputs both the first light and the second light may be used. In this case, the number of light sources can be reduced, thereby simplifying the configuration of the device. In addition, since the passing position of the first light and the passing position of the second light coincide with or are close to each other, the measurement accuracy can be further improved.

(10) In the concentration measurement device of (1) to (8) above, the light irradiator may include a first light source that outputs the first light, and a second light source that is provided separately from the first light source and that outputs the second light. Similarly, in the irradiating of the concentration measurement method of (1) to (8) above, a first light source that outputs the first light and a second light source that is provided separately from the first light source and that outputs the second light may be used. In this case, since the wavelengths can be set individually for the first light source and the second light source, the degree of freedom in selecting the first wavelength and the second wavelength can be increased.

(11) In the concentration measurement device of (1) to (10) above, the light detector may include a single light detection element that detects the light intensities of both the first light and the second light. Similarly, in the detecting of the concentration measurement method of (1) to (10) above, a single light detection element that detects the light intensities of both the first light and the second light may be used. In this case, the number of light detection elements can be reduced, thereby simplifying the configuration of the device. In addition, the passing position of the first light and the passing position of the second light can be easily made to coincide with or be brought close to each other, and the measurement accuracy can be further improved.

(12) In the concentration measurement device of (1) to (10) above, the light detector may include a first light detection element that detects the light intensity of the first light, and a second light detection element that detects the light intensity of the second light. Similarly, in the detecting of the concentration measurement method of (1) to (10) above, a first light detection element that detects the light intensity of the first light and a second light detection element that detects the light intensity of the second light may be used. In this case, since the wavelength sensitivity characteristics can be set individually for the first light detection element and the second light detection element, the degree of freedom in selecting the first wavelength and the second wavelength can be increased.

(13) In the concentration measurement device and the concentration measurement method of (1) to (12) above, when a region where a light intensity of the first light is 36.8% or more of a peak intensity of the first light is defined as a first spot and a region where a light intensity of the second light is 36.8% or more of a peak intensity of the second light is defined as a second spot, an area of an overlap between the first spot and the second spot when viewed in the first direction may be 35% or more of an area of the first spot, and may be 35% or more of an area of the second spot. In this case, by detecting the first absorbance and the second absorbance in the portion of the overlap between the first spot and the second spot, the measurement error in the optical path length due to an optical axis of the first light and an optical axis of the second light being spaced apart from each other can be reduced. Therefore, the measurement accuracy of the concentration of the sample can be further improved.

(14) In the concentration measurement device of (1) to (13) above, the light detector may detect the light intensities of the first light and the second light that have passed through the center of the internal region or a position spaced apart from the center of the internal region by a distance of ⅙ or less of the inner diameter of the side wall when viewed in the first direction. Similarly, in the detecting of the concentration measurement method of (1) to (13) above, the light intensities of the first light and the second light that have passed through the center of the internal region or a position spaced apart from the center of the internal region by a distance of ⅙ or less of the inner diameter of the side wall when viewed in the first direction may be detected. In this case, since the optical path of each of the first light and the second light that are detected is closer to the center of the liquid surface, the influence of the meniscus can be further reduced, and the length of the optical path in the liquid through which the first light passes and the length of the optical path in the liquid through which the second light passes can be brought closer to each other. Therefore, the measurement accuracy of the concentration of the sample can be further improved.

(15) In the concentration measurement device and the concentration measurement method of (1) to (14) above, a region where a light intensity of the first light is 36.8% or more of a peak intensity of the first light is defined as a first spot and a region where a light intensity of the second light is 36.8% or more of a peak intensity of the second light is defined as a second spot, diameters of the first spot and the second spot may be ⅓ or less of the inner diameter of the side wall having a tubular shape. In this way, since the diameters of the first spot and the second spot are not too large, the influence of stray light can be reduced, and the measurement accuracy of the concentration of the sample can be further improved.

(16) In the concentration measurement device and the concentration measurement method of (15) above, the diameters of the first spot and the second spot may be 2 mm or less.

The concentration measurement device and the concentration measurement method according to the present disclosure can also be expressed as follows.

(A1) A concentration measurement device according to another mode of the present disclosure includes: a well that includes a side wall having a tubular shape and extending along a first direction and a bottom portion closing one end of the side wall having a tubular shape, and that stores a liquid, in which a sample is dissolved or suspended in water, in an internal region formed by the side wall and the bottom portion; a light irradiator that irradiates the liquid with a first light having a first wavelength and a second light having a second wavelength such that the first light and the second light pass through both the bottom portion of the well and a liquid surface of the liquid; a light detector that detects light intensities of the first light and the second light that have passed through the liquid; and an arithmetic processor that calculates a concentration of the sample in the liquid based on an optical path length of the first light in the liquid, which is calculated from a first molar absorption coefficient that is a molar absorption coefficient of the liquid for the first light, and a second molar absorption coefficient that is a molar absorption coefficient of the liquid for the second light.

The light detector detects the light intensities of the first light and the second light that have passed through a center of the internal region or a position spaced apart from the center of the internal region by a distance of ¼ or less of an inner diameter of the side wall when viewed in the first direction.

A concentration measurement method according to another mode of the present disclosure includes: storing a liquid, in which a sample is dissolved or suspended in water, in an internal region formed by a side wall and a bottom portion of a well including the side wall having a tubular shape and extending along a first direction and the bottom portion closing one end of the side wall having a tubular shape; irradiating the liquid with a first light having a first wavelength and a second light having a second wavelength such that the first light and the second light pass through both the bottom portion of the well and a liquid surface of the liquid; detecting light intensities of the first light and the second light that have passed through the liquid; and calculating a concentration of the sample in the liquid based on an optical path length of the first light in the liquid, which is calculated from a first molar absorption coefficient that is a molar absorption coefficient of the liquid for the first light, and a second molar absorption coefficient is a molar absorption coefficient of the liquid for the second light.

In the detecting, the light intensities of the first light and the second light that have passed through a center of the internal region or a position spaced apart from the center of the internal region by a distance of ¼ or less of an inner diameter of the side wall when viewed in the first direction are detected.

In the concentration measurement device and the concentration measurement method, a molar absorption coefficient of the sample at the first wavelength may be 9×10⁵ (L/mol·cm) or less. A molar absorption coefficient of water at the first wavelength may be 0.4 (L/mol·cm) or more. A molar absorption coefficient of the sample at the second wavelength is 9×10⁶ (L/mol·cm) or more. A molar absorption coefficient of water at the second wavelength may be 0.002 (L/mol·cm) or less.

(A2) In the concentration measurement device and the concentration measurement method of (A1) above, the molar absorption coefficient of water at the first wavelength may be 4 (L/mol·cm) or less, and the molar absorption coefficient of the sample at the second wavelength may be 3×10¹⁰ (L/mol·cm) or less.

(A3) In the concentration measurement device and the concentration measurement method of (A1) and (A2) above, the molar absorption coefficient of water at the first wavelength may be 1 (L/mol·cm) or more and 2 (L/mol·cm) or less.

(A4) In the concentration measurement device and the concentration measurement method of (A1) to (A3) above, the molar absorption coefficient of the sample at the first wavelength may be 1×10⁶ (L/mol·cm) or less.

(A5) In the concentration measurement device and the concentration measurement method of (A1) to (A4) above, the molar absorption coefficient of the sample at the second wavelength may be 6×10⁷ (L/mol·cm) or more and 2×10¹⁰ (L/mol·cm) or less.

(A6) In the concentration measurement device and the concentration measurement method of (A1) to (A5) above, the molar absorption coefficient of water at the second wavelength may be 0.001 (L/mol·cm) or less.

(A7) In the concentration measurement device and the concentration measurement method of (A1) to (A6) above, the inner diameter of the side wall having a tubular shape may be 10 mm or less.

(A8) The concentration measurement device of (A1) to (A7) above may include a well plate in which the well and another well having the same structure as the well are provided side by side. The light irradiator may irradiate each of the liquid in the well and the liquid in the another well with both the first light and the second light. The light detector may detect the light intensities of the first light and the second light that have passed through the liquid in the well, and the light intensities of the first light and the second light that have passed through the liquid in the another well. The arithmetic processor may calculate the concentration of the sample in the well and the concentration of the sample in the another well.

(A9) In the concentration measurement device of (A1) to (A8) above, the light irradiator may include a single light source that outputs both the first light and the second light.

(A10) In the concentration measurement device of (A1) to (A8) above, the light irradiator may include a first light source that outputs the first light, and a second light source that is provided separately from the first light source and that outputs the second light.

(A11) In the concentration measurement device of (A1) to (A10) above, the light detector may include a single light detection element that detects the light intensities of both the first light and the second light.

(A12) In the concentration measurement device of (A1) to (A10) above, the light detector may include a first light detection element that detects the light intensity of the first light, and a second light detection element that detects the light intensity of the second light.

(A13) In the concentration measurement device and the concentration measurement method of (A1) to (A12) above, when a region where a light intensity of the first light is 36.8% or more of a peak intensity of the first light is defined as a first spot and a region where a light intensity of the second light is 36.8% or more of a peak intensity of the second light is defined as a second spot, an area of an overlap between the first spot and the second spot when viewed in the first direction may be 35% or more of an area of the first spot, and may be 35% or more of an area of the second spot.

(A14) In the concentration measurement device of (A1) to (A13) above, the light detector may detect the light intensities of the first light and the second light that have passed through the center of the internal region or a position spaced apart from the center of the internal region by a distance of ⅙ or less of the inner diameter of the side wall when viewed in the first direction.

(A15) In the concentration measurement device and the concentration measurement method of (A1) to (A14) above, a region where a light intensity of the first light is 36.8% or more of a peak intensity of the first light is defined as a first spot and a region where a light intensity of the second light is 36.8% or more of a peak intensity of the second light is defined as a second spot, diameters of the first spot and the second spot may be ⅓ or less of the inner diameter of the side wall having a tubular shape.

(A16) In the concentration measurement device and the concentration measurement method of (A15) above, the diameters of the first spot and the second spot may be 2 mm or less.

What is claimed is:

1. A concentration measurement device, comprising:
a well that includes a side wall having a tubular shape and extending along a first direction and a bottom portion closing one end of the side wall having a tubular shape, and that stores a liquid, in which a sample is dissolved or suspended in water, in an internal region formed by the side wall and the bottom portion;
a light irradiator that irradiates the liquid with a first light having a first wavelength and a second light having a second wavelength such that the first light and the second light pass through both the bottom portion of the well and a liquid surface of the liquid;
a light detector that detects light intensities of the first light and the second light that have passed through the liquid; and
an arithmetic processor that calculates a concentration of the sample in the liquid based on an optical path length of the first light in the liquid, which is calculated from a first absorbance that is an absorbance of the liquid for the first light, and a second absorbance that is an absorbance of the liquid for the second light,
wherein an absorbance of the sample at the first wavelength is 0.005 or less, and an absorbance of water at the first wavelength is 0.2 or more,
an absorbance of the sample at the second wavelength is 0.05 or more, and an absorbance of water at the second wavelength is 0.005 or less, and
the light detector detects the light intensities of the first light and the second light that have passed through a center of the internal region or a position spaced apart from the center of the internal region by a distance of ¼ or less of an inner diameter of the side wall when viewed in the first direction.

2. The concentration measurement device according to claim 1,
wherein the absorbance of water at the first wavelength is 2.0 or less, and the absorbance of the sample at the second wavelength is 1.5 or less.

3. The concentration measurement device according to claim 1, comprising:
a well plate in which the well and another well having a same structure as the well are provided side by side,
wherein the light irradiator irradiates each of the liquid in the well and the liquid in the another well with both the first light and the second light,
the light detector detects the light intensities of the first light and the second light that have passed through the liquid in the well, and the light intensities of the first light and the second light that have passed through the liquid in the another well, and
the arithmetic processor calculates the concentration of the sample in the well and the concentration of the sample in the another well.

4. The concentration measurement device according to claim 1,
wherein when a region where a light intensity of the first light is 36.8% or more of a peak intensity of the first light is defined as a first spot and a region where a light intensity of the second light is 36.8% or more of a peak intensity of the second light is defined as a second spot, an area of an overlap between the first spot and the second spot when viewed in the first direction is 35% or more of an area of the first spot, and is 35% or more of an area of the second spot.

5. The concentration measurement device according to claim 1,
wherein a region where a light intensity of the first light is 36.8% or more of a peak intensity of the first light is defined as a first spot and a region where a light intensity of the second light is 36.8% or more of a peak intensity of the second light is defined as a second spot, diameters of the first spot and the second spot are ⅓ or less of the inner diameter of the side wall having a tubular shape.

6. A concentration measurement method, comprising:
storing a liquid, in which a sample is dissolved or suspended in water, in an internal region formed by a side wall and a bottom portion of a well including the side wall having a tubular shape and extending along a first direction and the bottom portion closing one end of the side wall having a tubular shape;
irradiating the liquid with a first light having a first wavelength and a second light having a second wavelength such that the first light and the second light pass through both the bottom portion of the well and a liquid surface of the liquid;
detecting light intensities of the first light and the second light that have passed through the liquid; and
calculating a concentration of the sample in the liquid based on an optical path length of the first light in the liquid, which is calculated from a first absorbance that is an absorbance of the liquid for the first light, and a second absorbance that is an absorbance of the liquid for the second light,
wherein an absorbance of the sample at the first wavelength is 0.005 or less, and an absorbance of water at the first wavelength is 0.2 or more,
an absorbance of the sample at the second wavelength is 0.05 or more, and an absorbance of water at the second wavelength is 0.005 or less, and
in the detecting, the light intensities of the first light and the second light that have passed through a center of the internal region or a position spaced apart from the center of the internal region by a distance of ¼ or less of an inner diameter of the side wall when viewed in the first direction are detected.

7. The concentration measurement method according to claim 6,
wherein the absorbance of water at the first wavelength is 2.0 or less, and the absorbance of the sample at the second wavelength is 1.5 or less.

8. The concentration measurement method according to claim 6,
wherein the absorbance of water at the first wavelength is 0.5 or more and 1.0 or less.

9. The concentration measurement method according to claim 6,
wherein the absorbance of the sample at the first wavelength is 0.002 or less.

10. The concentration measurement method according to claim 6,
wherein the absorbance of the sample at the second wavelength is 0.3 or more and 1.0 or less.

11. The concentration measurement method according to claim 6,
wherein the absorbance of water at the second wavelength is 0.002 or less.

12. The concentration measurement method according to claim 6,
wherein the inner diameter of the side wall having a tubular shape is 10 mm or less.

13. The concentration measurement method according to claim 6,
wherein in the irradiating, a single light source that outputs both the first light and the second light is used.

14. The concentration measurement method according to claim 6,
wherein in the irradiating, a first light source that outputs the first light and a second light source that is provided separately from the first light source and that outputs the second light are provided.

15. The concentration measurement method according to claim 6,
wherein in the detecting, a single light detection element that detects the light intensities of both the first light and the second light is used.

16. The concentration measurement method according to claim 6,
wherein in the detecting, a first light detection element that detects the light intensity of the first light and a second light detection element that detects the light intensity of the second light are used.

17. The concentration measurement method according to claim 6,
wherein when a region where a light intensity of the first light is 36.8% or more of a peak intensity of the first light is defined as a first spot and a region where a light intensity of the second light is 36.8% or more of a peak intensity of the second light is defined as a second spot, an area of an overlap between the first spot and the second spot when viewed in the first direction is 35% or more of an area of the first spot, and is 35% or more of an area of the second spot.

18. The concentration measurement method according to claim 6,
wherein in the detecting, the light intensities of the first light and the second light that have passed through the center of the internal region or a position spaced apart from the center of the internal region by a distance of ⅙ or less of the inner diameter of the side wall when viewed in the first direction are detected.

19. The concentration measurement method according to claim 6,
wherein a region where a light intensity of the first light is 36.8% or more of a peak intensity of the first light is defined as a first spot and a region where a light intensity of the second light is 36.8% or more of a peak intensity of the second light is defined as a second spot, diameters of the first spot and the second spot are ⅓ or less of the inner diameter of the side wall having a tubular shape.

20. The concentration measurement method according to claim 19,
wherein the diameters of the first spot and the second spot are 2 mm or less.
